(19) United States
(12) Patent Application Publication
(10) Pub. No.: US 2008/0311954 A1
(43) Pub. Date: Dec. 18, 2008

(54) COMMUNICATION DEVICE WIRELESSLY CONNECTING FM/AM RADIO AND AUDIO DEVICE

(75) Inventors: Yu De Tsai, Taipei City (TW); Ying-Te Chu, Taipei County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: FORTEMEDIA, INC., Cupertino, CA (US)

(21) Appl. No.: 11/763,528

(22) Filed: Jun. 15, 2007

(51) Int. Cl. H04B 1/38

(52) U.S. Cl. 455/557

(57) ABSTRACT

A communication device includes a Bluetooth module, an audio interface, a FM/AM radio wave module, and a microphone. The Bluetooth module receives a first audio signal. The audio interface receives a second audio signal. The first audio signal and the second audio signal are selectively sent out through the FM/AM radio wave module. The microphone receives a third audio signal which is selectively sent out through either the Bluetooth module or the audio interface.

### BACKGROUND OF THE INVENTION

1. Field of the Invention

The invention relates to a communication device, and more particularly to a communication device wirelessly connecting to a FM/AM radio and an audio device.

2. Description of the Related Art

Cellular phones are becoming an increasingly attractive option for people who wish to communicate with business or personal acquaintances when they are away from domestic telephones. For example, cellular phones allow a car driver to make a phone call.

To make the phone call, the driver holds a cellular phone in one hand, and only the other hand remains free for manipulating the controls of the automobile such as the steering wheel and the stick shift. However, it is recommended that a person is able to talk on a cellular phone while having two hands free to properly manipulate the controls of an automobile.

### BRIEF SUMMARY OF THE INVENTION

The invention provides a communication device allowing the driver to communicate with a far-end talker without holding the cellular phone.

The invention also provides a communication device wirelessly connecting a FM/AM radio and an audio device.

The communication device may comprise a Bluetooth module, an audio interface, a FM/AM radio wave module, and a microphone. The Bluetooth module receives a first audio signal. The audio interface receives a second audio signal. The first audio signal and the second audio signal are selectively sent out through the FM/AM radio wave module. The microphone receives a third audio signal which is selectively sent out through either the Bluetooth module or the audio interface.

The communication device may further comprise a processor processing the first, second, and third audio signals.

The processor may execute noise suppression on the first and second audio signals.

The microphone may be an array microphone, and the processor may execute beam-forming, noise suppression, and echo cancellation on the third audio signal.

The communication device may further comprise a battery supplying power to the processor.

The communication device may further comprise a universal serial bus connector supplying power to the processor.

The communication device may further comprise a main body with the universal serial bus connector connected thereto.

The Bluetooth module, the processor, the FM/AM radio wave module, and the microphone may be disposed in the main body.

The processor may be a digital signal processor.

The audio interface may comprise an audio plug.

The communication device may further comprise a main body with the audio plug extending therefrom.

The communication device may further comprise a cap detachably connected to the main body to cover the audio plug.

### BRIEF DESCRIPTION OF THE DRAWINGS

The invention can be more fully understood by reading the subsequent detailed description and examples with references made to the accompanying drawings, wherein:

FIG. 1A depicts a communication device in accordance with a first embodiment of the invention;

FIG. 1B is a block diagram of the communication device in accordance with the first embodiment of the invention;

FIG. 2A depicts a first application example of the communication device of FIGS. 1A and 1B;

FIG. 2B is a block diagram of the communication device of FIG. 2A;

FIG. 3A depicts a second application example of the communication device of FIGS. 1A and 1B;

FIG. 3B is a block diagram of the communication device of FIG. 3A; and

FIG. 4 depicts a communication device in accordance with a second embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

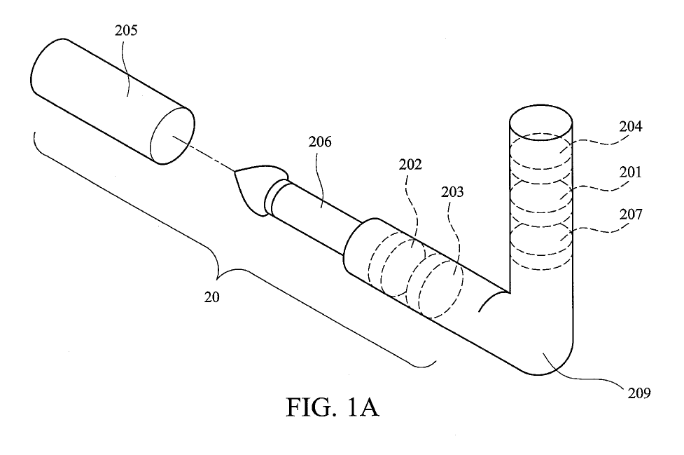

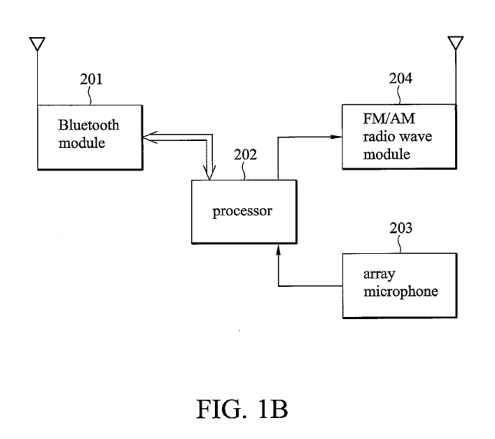

Referring to FIGS. 1A and 1B, a communication device 20 of a first embodiment of the invention includes a main body 209 and a cap 205. An audio plug (hereinafter the audio interface) 206 extends from the main body 209. The cap 205 is detachably connected to the main body 209 for protecting the audio interface 206. In the main body 209, a Bluetooth module 201, a processor (e.g. digital signal processor, DSP) 202, an array microphone 203, a FM/AM radio wave module 204, and a battery 207 are provided, wherein the battery 207 supplies power to all other elements 201, 202, 203, and 204.

In operation, the Bluetooth module 201 wirelessly receives a first audio signal from a first audio device (e.g. a cellular phone, a notebook computer, a personal digital assistant, an Apple iPOD, and others). Alternatively, the audio interface 206 receives a second audio signal from a second audio device (e.g. a cellular phone, a notebook computer, a personal digital assistant, an Apple iPOD, and others). Meanwhile, the array microphone 203 receives a third audio signal from a near-end talker. Then, the processor 202 processes the first, second, and third audio signals. The processed first and second audio signals are sent out through the FM/AM radio wave module 204, and the processed third audio signal is sent out through either the Bluetooth module 201 or the audio interface 206.

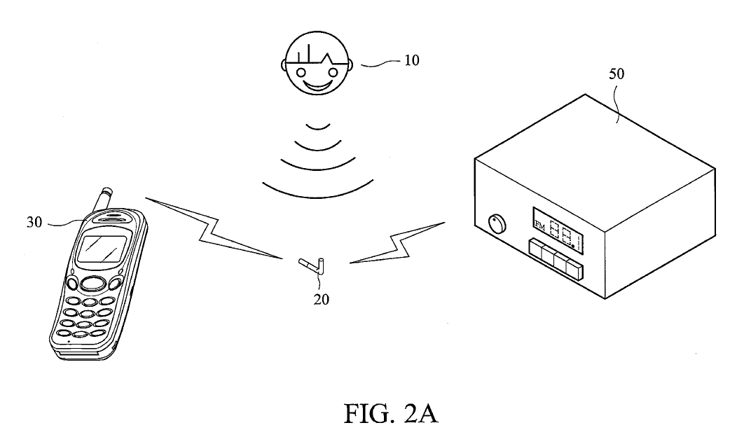

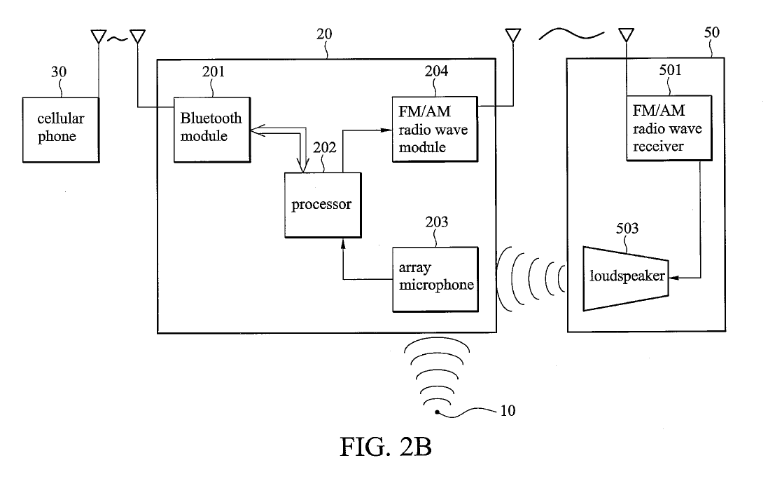

The communication device 20 of the invention allows a FM/AM radio to broadcast sound of various audio devices. In a first application example, the communication device 20 allows a car driver to make a phone call by using both a vehicle radio and a cellular phone, while the car driver does not need to hold the cellular phone. As depicted in FIG. 2A, on a phone call, the audio signal of a cellular phone 30 is wirelessly transmitted through the communication device 20 of the invention to the vehicle radio 50 so that the car driver/passengers 10 can hear the voice in the cellular phone 30 via the vehicle radio 50. Also, the communication device 20 receives sound from the car driver/passengers (i.e. the near-end talkers) 10 and wirelessly transmits it to the cellular phone 30 for the far-end talker's hearing.

FIG. 2B is a block diagram of the communication device 20, the cellular phone 30, and the vehicle radio 50 of FIG. 2A. During a phone call, the cellular phone 30 wirelessly receives the audio signal of a far-end talker and correspondingly sends a Bluetooth audio signal to the Bluetooth module 201. The Bluetooth module 201 demodulates the Bluetooth audio signal and transmits it to the processor 202. The processor 202 executes noise suppression and obtains a processed audio signal. The AM/FM radio wave module 204 modulates the processed audio signal, obtains a FM/AM radio signal, and sends it out. The FM/AM radio wave receiver 501 receives the FM/AM radio signal for the loudspeaker 503 to broadcast.

Furthermore, the array microphone 203 receives sound from the near-end talker 10 and generates another audio signal. The processor 202 receives the audio signal from the array microphone 203, executes beam-forming, noise suppression, and echo cancellation, and obtains a processed audio signal. The Bluetooth module 201 modulates the processed audio signal, obtains a Bluetooth audio signal, and wirelessly sends it out. The cellular phone 30 receives the Bluetooth audio signal from the Bluetooth module 201 for the far-end talker's hearing.

Note that the processor 202 executes echo cancellation to avoid the far-end talker from hearing echo, because the array microphone 203 not only receives the sound from the near-end talker (car driver/passengers) 10 but also the sound of the far-end talker from the loudspeaker 503.

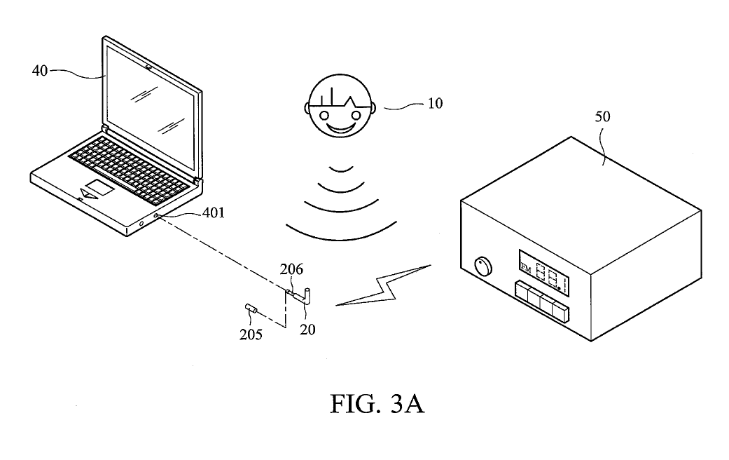

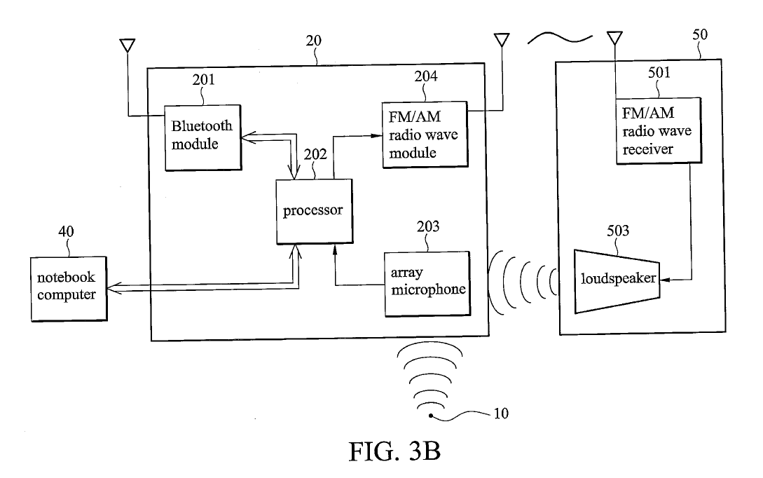

In a second application example, the communication device 20 allows a user to have a video meeting by using a radio and a notebook computer. The meeting may be held in a bedroom, a car, a hall, or other places. Referring to FIG. 3A, the cap 205 of the communication device 20 is removed to expose the audio interface 206. Then, the audio interface 206 is inserted into the sound jack 401 of the notebook computer 40. In the video meeting, the audio signal of the far-end talker is wirelessly transmitted from the notebook computer 40 through the communication device 20 to the radio 50 so that the radio 50 can broadcast the far-end talker's voice. Also, the communication device 20 receives sound from the user (i.e. the near-end talker) 10 and wirelessly transmits it to the notebook computer 40 for the far-end talker's hearing.

FIG. 3B is a block diagram of the communication device 20, the notebook computer 40, and the radio 50 of FIG. 3A. In the video meeting, the notebook computer 40 receives an audio signal from a far-end talker and sends an audio signal to the processor 202 through the audio interface 206. The processor 202 receives the audio signal from the notebook computer 40, executes noise suppression, and obtains a processed audio signal. The FM/AM radio wave module 204 modulates the processed audio signal, obtains a FM/AM radio signal, and sends it out. The radio receiver 501 receives the FM/AM radio signal for the loudspeaker 503 to broadcast.

Also, the array microphone 203 receives sound from both the near-end talker 10 and the loudspeaker 503 and generates an audio signal. The processor 202 receives the audio signal from the array microphone 203, executes beam-forming, noise suppression, and echo cancellation, and obtains a processed audio signal. The processed digital audio signal is transmitted through the audio interface 206 to the notebook computer 40 for the far-end talker's hearing.

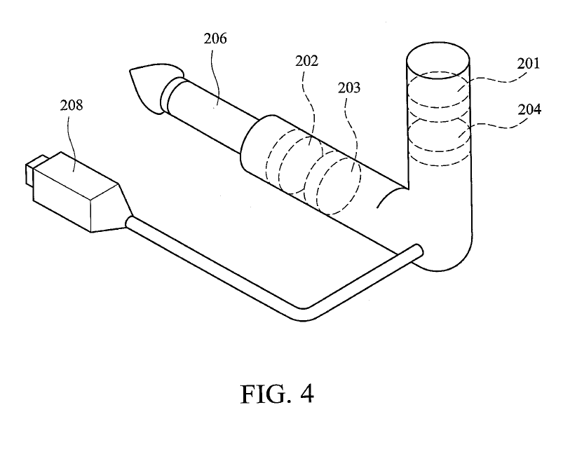

In the first embodiment, the battery 207 is disposed in the main body 209 for supplying power to other elements 201, 202, 203, and 204. The battery 207, however, can be replaced with a universal serial bus (USB) connector. FIG. 4 is a schematic diagram of a communication device in accordance with a second embodiment of the invention, wherein the same references will be used for elements which are identical or similar to those in the first embodiment. In the second embodiment, the communication device has a universal serial bus (USB) connector 208 connected to the main body 209. The universal serial bus (USB) connector 208 can be connected to a notebook computer or other electronic devices, supplying power to the Bluetooth module 201, the processor 202, the array microphone 203, and the FM/AM radio wave module 204.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A communication device, comprising:
a Bluetooth module receiving a first audio signal;
an audio interface receiving a second audio signal;
a FM/AM radio wave module selectively sending out either the first audio signal or the second audio signal;
a microphone receiving a third audio signal which is selectively sent out through either the Bluetooth module or the audio interface.

2. The communication device as claimed in claim 1, further comprising a processor processing the first, second, and third audio signals.

3. The communication device as claimed in claim 2, wherein the processor executes noise suppression on the first and second audio signals.

4. The communication device as claimed in claim 2, wherein the microphone is an array microphone, and the processor executes beam-forming, noise suppression, and echo cancellation on the third audio signal.

5. The communication device as claimed in claim 2, further comprising a battery supplying power to the processor.

6. The communication device as claimed in claim 2, further comprising a universal serial bus connector supplying power to the processor.

7. The communication device as claimed in claim 6, further comprising a main body with the universal serial bus connector connected thereto.

8. The communication device as claimed in claim 7, wherein the Bluetooth module, the processor, the FM/AM radio wave module, and the microphone are disposed in the main body.

9. The communication device as claimed in claim 2, wherein the processor is a digital signal processor.

10. The communication device as claimed in claim 1, wherein the audio interface comprises an audio plug.

11. The communication device as claimed in claim 10, further comprising a main body with the audio plug extending therefrom.

12. The communication device as claimed in claim 11, further comprising a cap detachably connected to the main body to cover the audio plug.
